(19) United States
(12) Patent Application Publication
(10) Pub. No.: US 2009/0085492 A1
(43) Pub. Date: Apr. 2, 2009

(54) Device for operating or starting a high-pressure discharge lamp lamp socket and illumination system wtih such a device and method for operation of a high-pressure discharge lamp

(75) Inventor: Bernhard Siessegger, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/918,473

(22) PCT Filed: Apr. 12, 2006
(86) PCT No.: PCT/DE2006/000656

§ 371 Date: Oct. 15, 2007

(30) Foreign Application Priority Data
Apr. 14, 2005 (EP) 05008228.8
May 2, 2005 (DE) 10 2005 020 773.1

(51) Int. Cl. H05B 41/36

(52) U.S. Cl. 315/209 R

(57) ABSTRACT

The invention relates to a device for operating or starting a high-pressure discharge lamp (10), whereby the device comprises a voltage-dependent switch (131), for generation of the starting voltage for the high-pressure discharge lamp (10), the switch threshold voltage of which is greater or equal to the starting voltage of the high-pressure discharge lamp (10) and a corresponding operating or starting method. The invention permits an impulse starting of the high-pressure discharge lamp (10) without use of a starter transformer. Said impulse starting device and said method may be advantageously combined with the high-frequency operation of the high-pressure discharge lamp (10), in particular, with a vehicle headlight high-pressure discharge lamp.

The invention relates to a device for operating or igniting a high-pressure discharge lamp in accordance with the precharacterizing clause of claim 1, a lamp base and a lighting system with such a device and a method for operating a high-pressure discharge lamp.

### I. PRIOR ART

Such a device has been disclosed, for example, in WO 98/53647. This laid-open specification describes a pulse ignition device for a high-pressure discharge lamp, in particular for a vehicle headlight high-pressure discharge lamp. This pulse ignition device has, as the essential elements, a spark gap, an ignition transformer and an ignition capacitor. In order to ignite the gas discharge in the high-pressure discharge lamp, the ignition capacitor is charged in order to then to be discharged via the spark gap and via the primary winding of the ignition transformer when the breakdown voltage of said spark gap is reached, so that the high voltage pulses required for ignition for the high-pressure discharge lamp are induced in the secondary winding of the ignition transformer. Once the gas discharge has been ignited, the high-pressure discharge lamp is generally operated with a substantially square-wave current at a frequency of below 1 kHz using a full-bridge inverter, as is described, for example, in the book “Betriebsgeräte und Schaltungen für elektrische Lampen” [Control gear and circuits for electric lamps] by C. H. Sturm/E. Klein, 6th edition, 1992, Siemens Aktiengesellschaft, on pages 217-218. One disadvantage here is the comparatively high complexity in terms of circuitry, in particular the two-stage design of the control gear with a step-up converter and a downstream full-bridge inverter as well as the required driving circuit for the semiconductor switches of the inverter and the step-up converter. In addition, the low lamp current frequency causes continuous fluctuations in the electrode temperature, which may result in jumps in the discharge arc attachment on the electrode surface and therefore in electromagnetic interference which is difficult to shield as well as in rapid changes in the luminance.

WO 2005/011339 A1 has disclosed control gear in the form of a class E converter for applying a substantially sinusoidal, high-frequency alternating current to a vehicle headlight high-pressure discharge lamp. The control gear comprises an ignition device for igniting the gas discharge in the high-pressure discharge lamp, the ignition device in accordance with one exemplary embodiment being in the form of a pulse ignition device, which has, as the essential elements, a spark gap, an ignition transformer and an ignition capacitor. In order to ignite the gas discharge in the high-pressure discharge lamp, the ignition capacitor is charged in order to then discharge via the spark gap and via the primary winding of the ignition transformer when the breakdown voltage of said spark gap is reached, so that the high voltage pulses required for ignition for the high-pressure discharge lamp are induced in the secondary winding of the ignition transformer. One disadvantage here is the fact that the secondary winding of the ignition transformer is connected into the lamp circuit and, as a result, once the gas discharge in the high-pressure discharge lamp has been ignited, the high-frequency lamp current flows through said secondary winding. Owing to the comparatively high impedance at high frequencies, in particular of greater than or equal to 100 kHz, of the secondary winding of the ignition transformer, in particular when ignition voltages of greater than 8 kV are required, a high voltage drop across the secondary winding which may be a multiple of the lamp running voltage is therefore produced during lamp operation. This results in losses in the transformer core and furthermore a correspondingly higher output voltage needs to be provided by the control gear or voltage converter. The reactive power to be provided which is caused by the secondary winding results in losses in the voltage converter. U.S. Pat. No. 6,194,844 has disclosed an ignition device for a high-pressure discharge lamp in which the lamp current does not need to flow through the secondary winding of an ignition transformer. However, with the proposed solution there is a capacitor in series with the high-pressure discharge lamp, which capacitor is charged by a DC voltage source to the ignition voltage of the high-pressure discharge lamp. FIG. 11 illustrates the basic circuit diagram of this DC voltage ignition. The DC voltage source 1104 charges the capacitor 1102 to the ignition voltage of the high-pressure discharge lamp in order to ignite the high-pressure discharge lamp 1103. One disadvantage of this solution is the fact that the alternating lamp current provided by the voltage converter 1101 needs to flow through this capacitor 1102 during subsequent operation. This arrangement is therefore only suitable for lamp operation with an extremely high frequency of the lamp current since otherwise the capacitance of said capacitor would need to be dimensioned to be very high and the energy stored in it would result in damage to the high-pressure discharge lamp when its discharge path breaks down.

Said capacitor should only cause low losses at the extremely high frequency of the lamp current in order to ensure a high degree of efficiency of the entire circuit, which makes this component very expensive. Furthermore, the finite resistance of the lamp vessel of a hot high-pressure discharge lamp in the case of immediate hot reignition, directly after the high-pressure discharge lamp has been disconnected, results in additional loading of the DC voltage source, since some of the current provided by it flows away via the hot lamp vessel. The lamp vessel which generally consists of quartz glass and is still hot once the high-pressure discharge lamp has been disconnected, in an unfavorable case has a resistance of only 15 megaohms to 20 megaohms, with the result that the resistance of the high-pressure discharge lamp in the disconnected state likewise only has a resistance in this range. FIG. 13 illustrates the resistance R of a vehicle headlight high-pressure discharge lamp with a discharge vessel consisting of quartz glass and a rated power of 35 watts in the disconnected state as a function of the time span t_{off}, which has elapsed since the disconnection of the high-pressure discharge lamp, for different running durations tₒₙ of the high-pressure discharge lamp. For example, the high-pressure discharge lamp at a running duration of five minutes has a resistance of less than 20 megaohms directly after disconnection. Approximately nine seconds after disconnection, its resistance value has increased to 100 megaohms. The rate of rise of the resistance value depends, in addition to the lamp itself, on the thermal capacity of the luminaire or the headlight and the thermal coupling thereof to the surrounding environment. The DC voltage source disclosed in U.S. Pat. No. 6,194,844 therefore cannot be implemented in the form of a voltage converter with a small piezo transformer having a low power.

### II. DESCRIPTION OF THE INVENTION

The object of the invention is to provide a device of the generic type for operating or igniting a high-pressure discharge lamp and a method for operating a high-pressure discharge lamp, in which the abovementioned disadvantages of the prior art do not occur.

This object is achieved according to the invention by a device having the features of claim 1 and by a method having the features of claim 19. Particularly advantageous embodiments of the invention are described in the dependent patent claims.

The device according to the invention for operating or igniting a high-pressure discharge lamp has a voltage-dependent switching means for producing the ignition voltage for the high-pressure discharge lamp, the switching threshold voltage of the voltage-dependent switching means being greater than or equal to the ignition voltage of the high-pressure discharge lamp. As a result, an ignition device can be realized which manages to produce the ignition voltage pulses for the high-pressure discharge lamp without the use of an ignition transformer or without the use of a capacitor, through which the lamp current must flow. Accordingly, the device according to the invention does not have the disadvantage explained above of the prior art during lamp operation with a high-frequency alternating current. The device according to the invention also makes it possible to produce substantially shorter ignition voltage pulses, since there is no ignition transformer involved whose parasitic elements would result in a broadening of the ignition voltage pulses. The device according to the invention can therefore be used particularly well in combination with control gear which supplies a high-frequency lamp current to the high-pressure discharge lamp.

The abovementioned ignition voltage of the high-pressure discharge lamp is the voltage required for igniting the gas discharge in the high-pressure discharge lamp. In order to be able to guarantee ignition of the gas discharge in all possible states of the high-pressure discharge lamp, for example ignition voltages of up to 30 kilovolts are required. Even in a favorable case, in which the high-pressure discharge lamp has been provided with an ignition aid, for example an ignition aid coating, which has been coupled capacitively to the gas discharge electrodes of the high-pressure discharge lamp, on the discharge vessel or on the outside or inside of an outer bulb surrounding the discharge vessel, the required ignition voltage can still be 8 kV. The switching threshold voltage of the voltage-dependent switching means is therefore preferably at least 8 kV.

In order to be able to generate such high ignition voltages in a simple manner, the voltage-dependent switching means comprises at least one spark gap. The switching threshold voltage, i.e. the breakdown voltage of the spark gap, can be adjusted to the desired value or to a value of greater than or equal to the ignition voltage of the high-pressure discharge lamp by changing the distance between its electrodes or by changing the pressure of the filling gas used. Alternatively, instead of one spark gap, a plurality of series-connected spark gaps or a spark gap which can be triggered externally with an additional ignition electrode can also be used for this purpose. Instead of spark gaps, however, other voltage-dependent switching means can also be used, for example thyristors or voltage-dependent resistors or a combination of the abovementioned component parts.

Preferably, a charge storage means which can be charged to the switching threshold voltage is provided in the device according to the invention in order to provide the energy for the breakdown of the voltage-dependent switching means. The abovementioned charge storage means is preferably one or more capacitors, which are designed for high voltages.

In accordance with the preferred exemplary embodiments of the invention, the charge storage means is preferably charged with the aid of a piezo transformer or a voltage multiplication circuit or a combination thereof. With the aid of the piezo transformer or the voltage multiplication circuit or a combination thereof, the required high voltages can be produced in a relatively simple manner. Voltage can be supplied to the piezo transformer directly by the voltage converter, which also generates the running voltage of this high-pressure discharge lamp. The voltage multiplication circuit is, for example, supplied with energy via a transformer, which is connected into the lamp circuit, and/or a series resonant circuit or else is connected downstream of the piezo transformer in order to once more increase its output voltage.

Advantageously, a voltage converter is provided in order to ensure the voltage supply of the voltage-dependent switching means during the ignition phase of the high-pressure discharge lamp from the system voltage, for example from the 230 volt low-voltage alternating current system or from the on-board electrical system voltage of a motor vehicle, and in order to supply a current or alternating polarity to the high-pressure discharge lamp. With the aid of the voltage converter, different operating modes can be realized in order to meet the different requirements of the high-pressure discharge lamp during its ignition phase and during lamp operation once the ignition phase has come to an end. Preferably, by means of the voltage converter, a first supply voltage for the voltage-dependent switching means is generated during the ignition phase of the high-pressure discharge lamp and a second supply voltage for producing a lamp current with alternating polarity is generated once the gas discharge in the high-pressure discharge lamp has been ignited.

The voltage converter is therefore preferably in the form of an inverter or AC voltage converter, which can be operated at different clock frequencies or switching frequencies. In order to produce the abovementioned first and second supply voltage, the inverter is preferably operated at switching frequencies from different frequency ranges. As a result, it is possible to ensure in a simple manner that, once the gas discharge in the high-pressure discharge lamp has been ignited, now only a low voltage is present at the voltage-dependent means as its switching threshold voltage and therefore no further ignition voltage pulses are generated.

Advantageously, a filter network is provided in order to protect the voltage converter from the ignition voltage pulse or the ignition voltage pulses during the ignition phase of the high-pressure discharge lamp. In the simplest case, the filter network can be formed by the lamp inductor, which limits the lamp current during lamp operation once the ignition phase of the high-pressure discharge lamp has come to an end. In addition, the filter network can comprise a low-pass filter, in order to further shield the voltage converter from the ignition voltage pulses, which have voltages from a substantially higher frequency spectrum than the lamp current. Once the gas discharge in the high-pressure discharge lamp has been ignited, the voltage-dependent switching means ensures DC isolation between the components of the ignition device and the voltage converter. As a result, complete deactivation of the device which provides for the charging of the charge storage means is not required and there is no danger of any negative effects, for example on the life of the high-pressure discharge lamp, as a result of a continuous direct current flow. This allows for a particularly simple implementation of the ignition device.

The device according to the invention only comprises a few components and therefore can be accommodated in the lamp base of a high-pressure discharge lamp. The device according to the invention can therefore be used particularly advantageously in metal-halide high-pressure discharge lamps for motor vehicle headlights, in particular also in mercury-free metal-halide high-pressure discharge lamps for motor vehicle headlights.

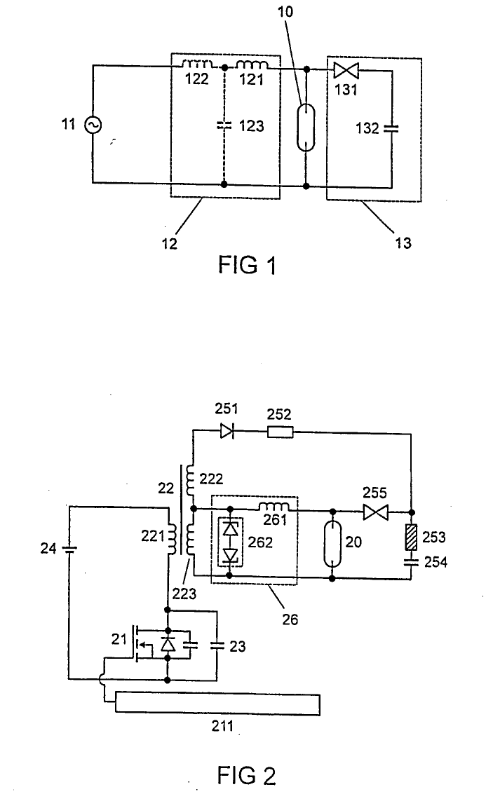

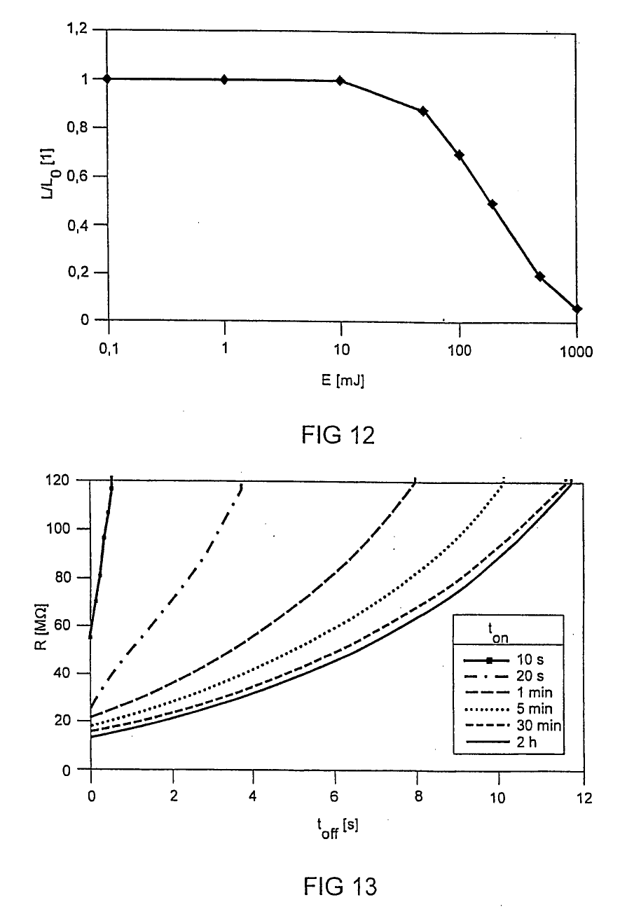

A very high current through the high-pressure discharge lamp or a high energy input within the relatively short duration of the ignition voltage pulse or pulses can result in erosion of electrode material, some of which is deposited on the inner surface of the discharge vessel. This results in damage to the electrode and in blackening and therefore impairment of the transparency of and increased thermal loading on the discharge vessel. In addition, this also influences the composition of the discharge plasma owing to the changed temperature distribution within the high-pressure discharge lamp. All factors bring about a reduction in the life of the high-pressure discharge lamp. FIG. 12 illustrates the standard life L/L₀ of 35 watt metal-halide high-pressure discharge lamps, which has been averaged over a number of test lamps, as a function of the energy E stored in the charge storage means at the time at which the switching threshold voltage is reached and the voltage-dependent switching means is switched over. The device shown in the exemplary embodiment illustrated in FIG. 1 with the spark gap 131 as the voltage-dependent switching means and the capacitor 132 as the charge storage means has been used for the measurement. The energy E is calculated on the basis of the following formula:

E=½C¹³²Uₛ²,

where C₁₃₂ is the capacitance of the charge storage means or of the capacitor 132, and Uₛ is the switching threshold voltage of the voltage-dependent switching means or the breakdown voltage of the spark gap 131.

The test series illustrated in FIG. 12 was carried out by changing the capacitance of the capacitor 132 and therefore the energy E. In this case it was shown that the capacitance C₁₃₂ of the capacitor 132 should be dimensioned such that the energy E resulting from the switching threshold voltage is less than 0.5 joule and preferably even less than 0.1 joule. With the last mentioned value for the energy E, the life of the high-pressure discharge lamps is still 70% of the comparison value L₀. Lamps with a higher rated power than 35 watts can be subjected to greater energy during the ignition operation given the same requirements for the life. In general, the capacitance C₁₃₂ of the charge storage means or the capacitor 132 should satisfy the following condition:

C₁₃₂<[(2·0.5J)/Uₛ²]·[P/35W] and preferably even

C₁₃₂<[(2·0.1 J)/Uₛ²]·[P/35 W], where P is the rated power of the high-pressure discharge lamp, Uₛ is the switching threshold voltage of the voltage-dependent switching means or the spark gap 131, and C₁₃₂ is the capacitance of the charge storage means or the capacitor 132.

For operation of a motor vehicle headlight metal-halide high-pressure discharge lamp with a rated power of 35 watts, the capacitance of the charge storage means of the device according to the invention is preferably less than 5.1 nF and particularly preferably even less than 3.2 nF.

The device according to the invention and the method according to the invention can be used both for high-pressure discharge lamps in which the ignition takes place via the two main electrodes, i.e. via their gas discharge electrodes, and for high-pressure discharge lamps which have been provided with an auxiliary ignition electrode.

### III. DESCRIPTION OF THE PREFERRED EXEMPLARY EMBODIMENTS

The invention will be explained in more detail below with reference to a plurality of preferred exemplary embodiments. In the drawing:

FIG. 1 shows the basic circuit diagram of a circuit arrangement for igniting and operating a high-pressure discharge lamp with the device according to the invention,

FIG. 2 shows a circuit diagram of the device in accordance with the first exemplary embodiment of the invention,

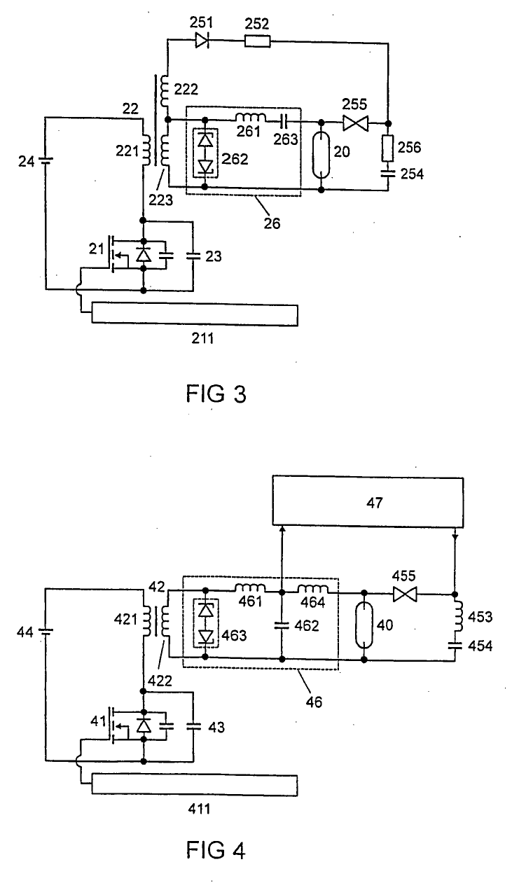

FIG. 3 shows a circuit diagram of the device in accordance with the second exemplary embodiment of the invention,

FIG. 4 shows a circuit diagram of the device in accordance with the third exemplary embodiment of the invention,

FIG. 5 shows a circuit diagram of the device in accordance with the fourth exemplary embodiment of the invention,

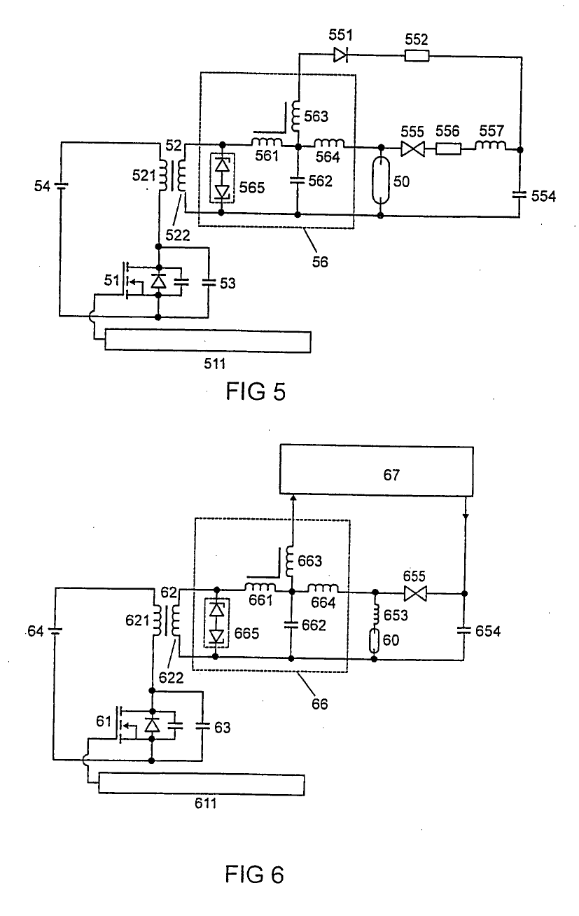

FIG. 6 shows a circuit diagram of the device in accordance with the fifth exemplary embodiment of the invention,

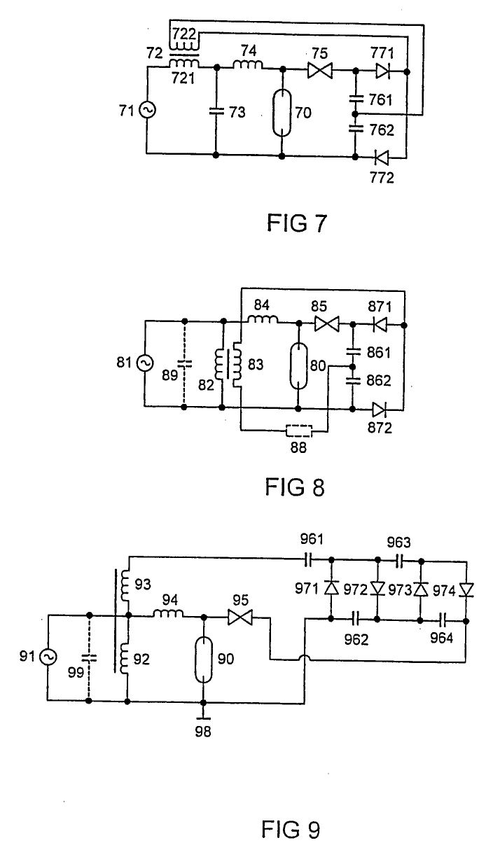

FIG. 7 shows a circuit diagram of the device in accordance with the sixth exemplary embodiment of the invention,

FIG. 8 shows a circuit diagram of the device in accordance with the seventh exemplary embodiment of the invention,

FIG. 9 shows a circuit diagram of the device in accordance with the eighth exemplary embodiment of the invention,

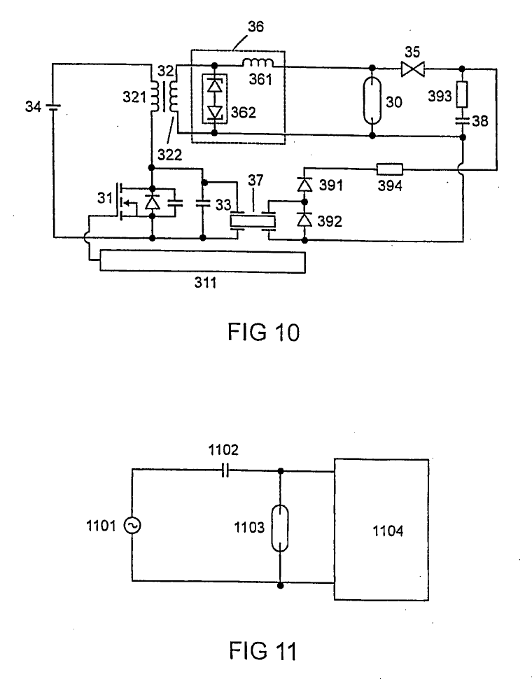

FIG. 10 shows a circuit diagram of the device in accordance with the ninth exemplary embodiment of the invention,

FIG. 11 shows the basic circuit diagram of a device for igniting and operating a high-pressure discharge lamp in accordance with the prior art,

FIG. 12 shows the life of the high-pressure discharge lamp as a function of the energy stored in the charge storage means at the ignition time, and

FIG. 13 shows the resistance of the high-pressure discharge lamp in the disconnected state as a function of the time span elapsed after disconnection of the high-pressure discharge lamp.

FIG. 1 is used to illustrate the basic principle of the ignition according to the invention and the operation of the high-pressure discharge lamp. The device for operating the high-pressure discharge lamp 10 comprises a voltage converter 11, which generates a high-frequency AC voltage from the system voltage, for example the on-board electrical system voltage of a motor vehicle or the AC system voltage of 230 volts or 120 volts, and a filter network 12 as well as an ignition device 13. In the simplest case, the filter network 12 only comprises the lamp inductor 121, through which the lamp current flows during lamp operation once the ignition phase of the high-pressure discharge lamp 10 has come to an end, and which lamp inductor limits said lamp current. The filter network 12 can therefore be used to stabilize the gas discharge in the high-pressure discharge lamp 10. In addition, the filter network 12 may optionally have a low-pass filter 122, 123, which is indicated by dashed lines in FIG. 1. The voltage converter 11 is, for example, a class E converter in accordance with WO 2005/011339 A1 or any other desired DC/AC converter or AC/AC converter. The ignition device 13 comprises a spark gap 131, whose breakdown voltage is greater than or equal to the hot reignition voltage of the high-pressure discharge lamp 10, i.e. is greater than or equal to the highest possible ignition voltage, and a capacitor 132, which can be charged to the breakdown voltage of the spark gap 131.

In order to ignite the gas discharge in the high-pressure discharge lamp 10, the voltage converter 11 is operated in a first operating mode in order to generate a first supply voltage for the ignition device 13 and to make it possible to charge the capacitor 132 to the breakdown voltage of the spark gap 131. The connection between the voltage converter 11 and the capacitor 132 and possibly additional elements of a charging arrangement is not illustrated in FIG. 1 for reasons of clarity. If the voltage at the capacitor 132 reaches the breakdown voltage of the spark gap 131, high voltage pulses are applied to the high-pressure discharge lamp which result in the gas discharge in the high-pressure discharge lamp being ignited. The filter network 12 protects the voltage converter 11 from these high voltage pulses during the ignition phase of the high-pressure discharge lamp 10, which high voltage pulses have a width or duration of approximately 10 to 950 nanoseconds. Then, the voltage converter 11 is operated in a second operating mode in order to generate a second supply voltage for the high-pressure discharge lamp 10 and in order to supply said high-pressure discharge lamp with an alternating current whose frequency is above 100 kHz. The frequency of the lamp current, this being understood to mean the fundamental frequency or fundamental in a Fourier analysis of the profile of the lamp current over time, is markedly lower than the frequency spectrum of the abovementioned high voltage pulses during the ignition phase of the high-pressure discharge lamp 10, which permits operation of the high-pressure discharge lamp 10 by means of the voltage converter 11 despite the filter 12, and at the same time makes protection of the voltage converter 11 from the high voltage pulses of the ignition device 13 possible. During the second operating mode of the voltage converter 11, the capacitor 132 is now only charged to a lower voltage than the breakdown voltage of the spark gap 131, so that the spark gap 131 brings about potential isolation between the ignition device 13 and the voltage converter 11 as well as the high-pressure discharge lamp 10 during lamp operation, once the ignition phase has come to an end.

Once ignition has taken place, the voltage converter 11 supplies a lamp current with a frequency of 1.3 MHz to the high-pressure discharge lamp 10. The inductor 121 is in the form of an inductor which is resistant to high voltages and has an inductance of 11 μH or 38 μH. The lamp 10 is a mercury-free or mercury-containing metal-halide high-pressure discharge lamp with a rated power of 35 watts and a rated running voltage of 45 volts or 85 volts, which is provided for use in a motor vehicle headlight. The spark gap 131 has a switching threshold voltage or breakdown voltage of 25 kV. The capacitor 132 is designed for a voltage of up to 30 kV and has a capacitance of 100 pF. The given inductance values of the inductors 121 are in this case selected such that, in addition to the protection of the voltage converter 11, stabilization of the gas discharge current is also brought about. If, once ignition has taken place, the high-pressure discharge lamp is operated with a lamp current with a frequency of 700 kHz instead of the abovementioned 1.3 MHz, the inductor 121 is dimensioned such that its inductance is 20 pH in the case of the mercury-free metal-halide high-pressure discharge lamp and 70 pH in the case of the mercury-containing metal-halide high-pressure discharge lamp.

FIG. 2 illustrates, schematically, a first exemplary embodiment of the device according to the invention. The voltage converter is in the form of a single-transistor converter, which comprises a field effect transistor 21 with an integrated body diode and parasitic capacitance as well as a transformer 22 with a primary winding 221 and two secondary winding sections 222, 223 and a capacitor 23, which is connected in parallel with the field effect transistor 21 and in series with the primary winding 221. The gate of the field effect transistor 21 is connected to a driving device 211. A DC voltage source 24, for example the on-board electrical system voltage of a motor vehicle, is used for the voltage supply. The first secondary winding section 222 is used for supplying voltage to the ignition device, which is formed by the rectifier diode 251, the resistor 252, the current-limiting element 253, the capacitor 254 and the spark gap 255. The current-limiting element 253 illustrated by hatching in FIG. 2 is optional. For example, a resistor, an inductor or a series circuit comprising the abovementioned component parts can be used as the current-limiting element 253. In addition, the element 253 increases the electromagnetic compatibility of the circuit or device. It serves the purpose of protecting the gas discharge electrodes of the high-pressure discharge lamp 20 and the spark gap 255 from an excessively high discharge current of the capacitor 254 and extends the life of the capacitor owing to a reduced pulse loading. It can be used, in particular in the case of a low switching frequency of the voltage converter, for the purpose of extending the temporal extent of the high voltage pulse or the high voltage pulses, so that the low-resistance state of the high-pressure discharge lamp is maintained until the current supplied by the voltage converter takes care of this.

The breakdown voltage of the spark gap 255, as has already been explained above, is matched to the ignition voltage of the high-pressure discharge lamp 20. The second secondary winding section 223 of the transformer 22 supplies the lamp circuit, which in this case is formed by the filter network 26, comprising the lamp inductor 261 and the Transil diode 262, and the high-pressure discharge lamp 20.

In order to ignite the gas discharge in the high-pressure discharge lamp, the switching frequency of the transistor 21 is controlled by means of the driving device in such a way that it is close to the resonant frequency of the series resonant circuit, which is formed by the capacitor 23 and the primary winding 221. In this case, a frequency modulation of the switching frequency can be carried out in order to ensure excitation of the resonance irrespective of the tolerances of the component parts used for the series resonant circuit. As a result, a sufficiently high voltage is induced in the first secondary winding section 222 in order to charge the capacitor 254 via the rectifier diode 251 and the resistor 252 and the current-limiting component 253 to the breakdown voltage of the spark gap 255. When the breakdown voltage of the spark gap 255 is reached, the capacitor 254 is discharged via the current-limiting component 253 and the spark gap 255, so that one or more high voltage pulses are applied to the high-pressure discharge lamp 20 which result in the gas discharge in the high-pressure discharge lamp 20 being ignited. Then, the switching frequency of the transistor 21 is controlled by means of the driving device 221 in such a way that it is outside the resonance of the resonant circuit 23, 221 and a sufficiently high AC voltage is induced at the second secondary winding section 223 in order to be able to operate the high-pressure discharge lamp 20 with its running voltage of approximately 45 volts in the case of a mercury-free metal-halide high-pressure discharge lamp or of approximately 85 volts in the case of a mercury-containing metal-halide high-pressure discharge lamp. The capacitor 254 is as a result no longer charged to the breakdown voltage of the spark gap 255, so that also no further high voltage pulses are generated. The switching frequency of the transistor 21 is above 100 kHz, preferably in the range of from 0.3-3.5 MHz, so that the lamp current flowing through the lamp inductor 261 and via the discharge path of the lamp 20 likewise has this frequency. The lamp inductor 261 is used for limiting the lamp current. The Transil diode 262 protects the transformer 22 and the transistor 21 during the ignition phase of the lamp 20 from the high voltage pulses of the spark gap 255.

FIG. 3 illustrates a second exemplary embodiment of the invention, which differs from the exemplary embodiment depicted in FIG. 2 merely by an additional capacitor 263, which is connected in series with the lamp inductor 261 and is used for partially compensating for the inductance of the lamp inductor 261, and by the current-limiting component 256, which is in the form of a resistor. In all other details and also the manner in which they function, the first and second exemplary embodiments correspond to one another. The same reference symbols have therefore been used for identical component parts in FIGS. 2 and 3. FIG. 4 illustrates a third exemplary embodiment of the invention. The voltage converter is in the form of a single-transistor converter, which comprises a field effect transistor 41 with an integrated body diode and parasitic capacitance as well as a transformer 42 with a primary winding 421 and a secondary winding 422 as well as a capacitor 43, which is connected in parallel with the field effect transistor 41 and in series with the primary winding 421. The gate of the field effect transistor 41 is connected to a driving device 411. A DC voltage source 44, for example the on-board electrical system voltage of a motor vehicle, is used for voltage supply. A filter network 46, which comprises a low-pass filter 461, 462, 464 and a Transil diode 463, which is arranged in parallel with the secondary winding, is connected to the secondary winding 442, the inductances 461, 464 and the lamp inductor having a stabilizing effect on the lamp current. The high-pressure discharge lamp 40 is connected to the filter network 46. The voltage input of a voltage multiplication circuit 47 with an integrated rectifier is connected at the center tap between the low-pass capacitor 462 and the inductances 461, 464, which voltage multiplication circuit 47 is used to supply voltage to the components 453, 454, 455 of the ignition device for the high-pressure discharge lamp 40.

In order to ignite the gas discharge in the high-pressure discharge lamp, the switching frequency of the transistor 41 is controlled by means of the driving device 411 in such a way that it is close to the resonant frequency of the series resonant circuit, which is formed by the capacitor 462 and the inductor 461. As a result, a correspondingly high input voltage for the voltage multiplication circuit 47 is provided in order to charge the capacitor 454 to the breakdown voltage of the spark gap 455. When the breakdown voltage of the spark gap 455 is reached, the capacitor 454 is discharged via the inductor 453 and the spark gap 455, so that one or more high voltage pulses are applied to the high-pressure discharge lamp 40 which result in the gas discharge in the high-pressure discharge lamp 40 being ignited. The inductor 453 is used for protecting the lamp electrodes and the spark gap 455 from an excessively high discharge current of the capacitor 454. Then, the switching frequency of the transistor 41 is controlled by means of the driving device 411 in such a way that a sufficiently high AC voltage is induced in a secondary winding 422 in order to be able to operate the high-pressure discharge lamp 40 with its running voltage of approximately 40 volts in the case of a mercury-free metal-halide high-pressure discharge lamp or of approximately 85 volts in the case of a mercury-containing metal-halide high-pressure discharge lamp. The capacitor 454 is no longer charged to the breakdown voltage of the spark gap 455, since the resonant circuit 461, 462 is no longer excited so as to be close to the resonant frequency, or the damping of the resonant circuit by means of the now ignited high-pressure discharge lamp 40 is so great that no further high voltage pulses are generated. The switching frequency of the transistor 41 is above 100 kHz, preferably in the range of from 0.3-3.5 MHz, so that the lamp current flowing through the lamp inductors 461, 464 and via the discharge path of the lamp 40 likewise has this frequency. The lamp inductors 461, 464 are used to limit the lamp current. The Transil diode 463 protects the transformer 42 and the transistor 41 from the high voltage pulses of the spark gap 455 during the ignition phase of the lamp 40.

FIG. 5 illustrates a fourth exemplary embodiment of the invention. The voltage converter is in the form of a single-transistor converter, which comprises a field effect transistor 51 with an integrated body diode and parasitic capacitance as well as a transformer 52 with a primary winding 521 and a secondary winding 522 as well as a capacitor 53, which is connected in parallel with the field effect transistor 51 and in series with the primary winding 521. The gate of the field effect transistor 51 is connected to a driving device 511. A DC voltage source 54, for example the on-board electrical system voltage of a motor vehicle, is used for voltage supply. A filter network 56, which comprises an autotransformer 561, 563, a capacitor 562, a Transil diode 565, which is arranged in parallel with the secondary winding 522, and the inductor 564, is connected to the secondary winding 522. The primary winding section 561 of the autotransformer and the inductor 564 form a low-pass filter with the capacitor 562. The high-pressure discharge lamp 50 is connected to the filter network 56. The secondary winding section 563 of the autotransformer is used for supplying voltage to the ignition device, which is formed by the rectifier diode 551, the resistor 552, the inductor 557, the capacitor 554 and the spark gap 555. The resistor 556 and the inductor 557 are optional. They are used for protecting the gas discharge electrodes of the high-pressure discharge lamp 50 and the spark gap 555 from an excessively high discharge current of the capacitor 554. The breakdown voltage of the spark gap 555, as has already been explained above, is matched to the ignition voltage of the high-pressure discharge lamp in all exemplary embodiments.

In order to ignite the gas discharge in the high-pressure discharge lamp, the switching frequency of the transistor 51 is controlled by means of the driving device 511 in such a way that it is close to the resonant frequency of the series resonant circuit, which is formed by the capacitor 562 and the primary winding 561. As a result, a sufficiently high voltage is induced in the secondary winding section 563 of the autotransformer in order to charge the capacitor 554 to the breakdown voltage of the spark gap 555. When the breakdown voltage of the spark gap 555 is reached, the capacitor 554 is discharged via the resistor 556 and the inductor 557 as well as the spark gap 555, so that one or more high voltage pulses are applied to the high-pressure discharge lamp 50 which result in the gas discharge in the high-pressure discharge lamp 50 being ignited. Then, the switching frequency 51 is controlled by means of the driving device 511 in such a way that it is outside the resonance of the resonant circuit 561, 562 and a sufficiently high AC voltage is induced in the secondary winding 562 in order to be able to operate the high-pressure discharge lamp 50 with its running voltage of approximately 45 volts in the case of a mercury-free metal-halide high-pressure discharge lamp or of approximately 85 volts in the case of a mercury-containing metal-halide high-pressure discharge lamp. As a result, the capacitor 554 is no longer charged to the breakdown voltage of the spark gap 555, so that also no further high voltage pulses are generated. The switching frequency of the transistor 51 is above 100 kHz, preferably in the range or from 0.3-3.5 MHz, so that the lamp current flowing through the lamp inductor 564 and via the discharge path of the lamp 50 likewise has this frequency. The primary winding 561 and the inductor 564 are used to limit the lamp current. The Transil diode 565 protects the transformer 52 and the transistor 51 from the high voltage pulses of the spark gap 555 during the ignition phase of the lamp 50.

FIG. 6 illustrates a fifth exemplary embodiment of the invention. The voltage converter is in the form of a single-transistor converter, which comprises a field effect transistor 61 with an integrated body diode and parasitic capacitance as well as a transformer 62 with a primary winding 621 and a secondary winding 622 as well as a capacitor 63, which is connected in parallel with the field effect transistor 61 and in series with the primary winding 621. The gate of the field effect transistor 61 is connected to a driving device 611. A DC voltage source 64, for example the on-board electrical system voltage of a motor vehicle, is used for voltage supply. A filter network 66, which comprises an autotransformer 661, 663, a capacitor 662, a Transil diode 665, which is arranged in parallel with the secondary winding 622, and the inductor 664, is connected to the secondary winding 622. The primary winding section 661 of the autotransformer forms a low-pass filter with the capacitor 662. The high-pressure discharge lamp 60 is connected to the filter network 66. The secondary winding section 663 of the autotransformer is used for supplying voltage to a voltage multiplication circuit 67 with an integrated rectifier, whose output voltage is in turn used for charging the capacitor 654 to the breakdown voltage of the spark gap 655. The voltage multiplication circuit 67 with the integrated rectifier can be formed, for example, substantially by a single-stage or multi-stage cascade circuit, which is also referred to as a Cockcroft-Walton circuit. The inductor 653 is used for protecting the high-pressure discharge lamp 60 and the spark gap 655 from an excessively high discharge current of the capacitor 654 during the ignition phase. Alternatively, the inductor 653 can also be inserted into the circuit such that there is no high-frequency lamp current flowing through it once the lamp 60 has been ignited and there is no charging current of the capacitor 654 flowing through it during the ignition phase, but only the discharge current of the capacitor 654 flows through it. In the arrangement illustrated, the inductor 653 can furthermore be used to stabilize the discharge and to increase the electromagnetic compatibility during ignition and subsequent lamp operation.

In order to ignite the gas discharge in the high-pressure discharge lamp, the switching frequency of the transistor 61 is controlled by means of the driving device 611 in such a way that it is close to the resonant frequency of the series resonant circuit, which is formed by the capacitor 662 and the primary winding 661. As a result, a sufficiently high input voltage for the voltage multiplication circuit 67 is provided in order to charge the capacitor 654 to the breakdown voltage of the spark gap 655. When the breakdown voltage of the spark gap 655 is reached, the capacitor 654 is discharged via the spark gap 655 and the inductor 653, so that one or more high voltage pulses are applied to the high-pressure discharge lamp 60 which result in the gas discharge in the high-pressure discharge lamp 60 being ignited. Then, the switching frequency of the transistor 61 is controlled by means of the driving device 611 in such a way that it is outside the resonance of the resonant circuit 661, 662 and a sufficiently high AC voltage is induced in the secondary winding 622 in order to be able to operate the high-pressure discharge lamp 60 with its running voltage of approximately 45 volts in the case of a mercury-free metal-halide high-pressure discharge lamp or of approximately 85 volts in the case of a mercury-containing metal-halide high-pressure discharge lamp. As a result, the capacitor 654 is no longer charged to the breakdown voltage of the spark gap 655, so that also no further high voltage pulses are generated. The switching frequency of the transistor 41 is above 100 kHz, preferably in the range of from 0.3-3.5 MHz, so that the lamp current flowing through the inductive components 661, 664 and 653 and via the discharge path of the lamp 60 likewise has this frequency. The primary winding 661 and the inductors 664 and 653 are used to limit the lamp current. The Transil diode 665 protects the transformer 62 and the transistor 61 from the high voltage pulses of the spark gap 655 during the ignition phase of the lamp 60.

FIG. 7 illustrates a sixth exemplary embodiment of the device according to the invention for igniting and operating the high-pressure discharge lamp 70. The device comprises a voltage converter 71, which generates a high-frequency AC voltage from the on-board electrical system voltage of a motor vehicle, a transformer 72 with a primary winding 721 and a secondary winding 722, a capacitor 73, a lamp inductor 74 and an ignition device for the high-pressure discharge lamp 70, which comprises the spark gap 75 and a balanced voltage doubling circuit. The voltage doubling circuit is formed by the capacitors 761, 762 and the diodes 771, 772. The primary winding 721 and the inductor 74 as well as the capacitor 73 form a low-pass filter, which protects the voltage converter 71 from the high voltage pulses during the ignition phase.

During the ignition phase of the high-pressure discharge lamp 70, the voltage doubling circuit 761, 762, 771, 772 is supplied with a sufficiently high voltage from the voltage via the secondary winding 722 in order to charge the capacitors 761 and 762 at the output of the voltage doubling circuit to the breakdown voltage of the spark gap 75, so that one or more high voltage pulses are applied to the high-pressure discharge lamp 70 for igniting the gas discharge.

Once the ignition phase has come to an end, the voltage drop across the secondary winding 722 is no longer sufficient for charging the capacitors 761 and 762 to the breakdown voltage of the spark gap 75. In this case, a change in the switching frequency of the voltage converter 71 can take place once the ignition phase has come to an end if damping of the resonant circuit comprising the primary winding 721 and the capacitor 73 by means of the ignited high-pressure discharge lamp 70 is insufficient.

FIG. 8 illustrates a seventh exemplary embodiment of the device according to the invention for igniting and operating the high-pressure discharge lamp 80. The device comprises a voltage converter 81, which generates a high-frequency AC voltage from the on-board electrical system voltage of a motor vehicle, a transformer with a primary winding 82 and a secondary winding 83, an optional capacitor 89 in parallel with the voltage output of the voltage converter 81, a lamp inductor 84 and an ignition device for the high-pressure discharge lamp 80, which comprises the spark gap 85 and a symmetrical voltage doubling circuit. The voltage doubling circuit is formed by the capacitors 861, 862 and the diodes 871, 872 and an optional resistor 88. The optional resistor 88 is used as a charging resistor and prevents damage to the diodes 871 and 872 by means of an excessively high current in the case of virtually discharged capacitors 861 and 862. For example, it is possible to dispense with the resistor 44 if the transformer 82, 83 is designed to have sufficiently little coupling between the primary winding 82 and the secondary winding 83. Owing to the comparatively high internal impedance of the voltage converter 81, its output voltage drops so severely when the ignition phase of the high-pressure discharge lamp 80 has come to an end that the breakdown voltage of the spark gap 85 is no longer reached.

FIG. 9 illustrates an eighth exemplary embodiment of the device according to the invention for igniting and operating the high-pressure discharge lamp 90. The device comprises a voltage converter 91, which generates a high-frequency AC voltage from the on-board electrical system voltage of a motor vehicle, a transformer with a primary winding 92 and a secondary winding 93, an optional capacitor 99 in parallel with the voltage output of the voltage converter 91, a lamp inductor 94 and an ignition device for the high-pressure discharge lamp 90, which comprises the spark gap 95 and an unbalanced voltage doubling circuit. The voltage doubling circuit or two-stage cascade circuit is formed by the capacitors 961, 962, 963, 964 and the diodes 971, 972, 973, 974. One electrode of the high-pressure discharge lamp 90 is connected to the ground reference potential 98, and its other electrode is connected to a terminal of the spark gap 95.

During the ignition phase of the high-pressure discharge lamp 90, the voltage doubling circuit 961, 962, 963, 964, 971, 972, 973, 974 is supplied with a sufficiently high voltage from the voltage at the secondary winding 93 in order to charge the capacitors 962 and 964 at the output of the voltage doubling circuit to the breakdown voltage of the spark gap 95, so that one or more high voltage pulses can be applied to the high-pressure discharge lamp 90 for igniting the gas discharge.

Once the ignition phase has come to an end, the voltage converter 91 is operated at another switching frequency, so that, owing to its internal impedance, its output voltage, which corresponds to the voltage at the secondary winding 93, is no longer sufficient for charging the capacitors 962 and 964 to the breakdown voltage of the spark gap 95.

FIG. 10 illustrates a ninth exemplary embodiment of the invention. The voltage converter is in the form of a single-transistor converter, which comprises a field effect transistor 31 with an integrated body diode and parasitic capacitance as well as a transformer 32 with a primary winding 321 and a secondary winding 322 as well as a capacitor 33, which is connected in parallel with the field effect transistor 31 and in series with the primary winding 321. The gate of the field effect transistor 31 is connected to a driving device 311. A DC voltage source 34, for example the on-board electrical system voltage of a motor vehicle, is used for voltage supply. A filter network 36, which comprises a Transil diode 362, which is arranged in parallel with the secondary winding, and the lamp inductor 361, is connected to the secondary winding 322. The high-pressure discharge lamp 30 is connected to the filter network 36. The ignition device for the high-pressure discharge lamp 30 comprises a piezo transformer 37, whose voltage input is connected to the capacitor 33, diodes 391, 392, which are connected to the voltage output of the piezo transformer 37 and form a voltage doubling circuit with the internal capacitances of the piezo transformer 37 on the secondary side, and the resistors 393, 394 as well as the capacitor 38 and the spark gap 35.

In order to ignite the gas discharge in the high-pressure discharge lamp 30, the switching frequency of the transistor 31 is controlled by means of the drive device 311 such that a resonance of the piezo transformer 37 is excited. On the secondary side of the piezo transformer 37, its output voltage is doubled by means of the voltage doubling circuit 391, 392, so that the capacitor 38 is charged to the breakdown voltage of the spark gap 35 via the resistors 393 and 394. As a result, the capacitor 38 is discharged via the resistor 393 and the spark gap 35, one or more high voltage pulses being applied to the high-pressure discharge lamp 30 which result in the gas discharge in the high-pressure discharge lamp 30 being ignited.

Once the gas discharge in the high-pressure discharge lamp 30 has been ignited, the switching frequency of the transistor 31 is controlled by means of the driving device 311 such that it is outside the resonance of the piezo transformer 37 and a sufficiently high AC voltage is induced at the secondary winding 322 in order to be able to operate the high-pressure discharge lamp 30 with its running voltage of approximately 45 volts in the case of a mercury-free metal-halide high-pressure discharge lamp or of approximately 85 volts in the case of a mercury-containing metal-halide high-pressure discharge lamp. The capacitor 38 is no longer charged to the breakdown voltage of the spark gap 35, since no resonance of the piezo transformer 37 is excited once the ignition phase has come to an end, so that also no further high voltage pulses are generated. The switching frequency of the transistor 31 is above 100 kHz, preferably in the range of from 0.3-3.5 MHz, so that the lamp current flowing through the lamp inductor 361 and via the discharge path of the lamp 30 likewise has this frequency. The lamp inductor 361 is used to limit the lamp current. The Transil diode 362 protects the transformer 32 and the transistor 31 from the high voltage pulses of the spark gap 35 during the ignition phase of the lamp 30. The spark gap 35 ensures potential isolation between the secondary side of the piezo transformer 37 and the voltage converter 31, 32 once the ignition phase has come to an end.

In contrast to the circuit arrangement proposed in the prior art, the piezo transformer is now not loaded by the parasitic resistance of a possibly still hot high-pressure discharge lamp during charging of the capacitor 38, as illustrated in FIG. 13. It is therefore possible to use substantially smaller and more cost-effective piezo transformers than was possible in accordance with the prior art.

1. A device for operating or igniting a high-pressure discharge lamp (10), the device having a voltage-dependent switching means (131) for producing the ignition voltage for the high-pressure discharge lamp (10), characterized in that the switching threshold voltage of the voltage-dependent switching means (131) is greater than or equal to the ignition voltage of the high-pressure discharge lamp (10).

2. The device as claimed in claim 1, characterized in that the switching threshold voltage of the voltage-dependent switching means (131) is greater than or equal to 8 kilovolts.

3. The device as claimed in claim 1, characterized in that the voltage-dependent switching means comprises at least one spark gap (131).

4. The device as claimed in claim 1, characterized in that a charge storage means (132) is provided which can be charged to the switching threshold voltage.

5. The device as claimed in claim 4, characterized in that the charge storage means (132) has a capacitance of less than or equal to 5.1 nF.

6. The device as claimed in claim 4, characterized in that the capacitance of the charge storage means (132) satisfies the following condition:
C₁₃₂<[(2·0.5J)/Uₛ²]·[P/35W],
where P is the rated power of the high-pressure discharge lamp (10), Uₛ is the switching threshold voltage of the voltage-dependent switching means (131) and C₁₃₂ is the capacitance of the charge storage means (132).

7. The device as claimed in claim 4, characterized in that the charge storage means comprises at least one capacitor (132).

8. The device as claimed in claim 4, characterized in that a piezo transformer (37) and/or a voltage multiplication circuit (47) are provided for charging the charge storage means (38, 454).

9. The device as claimed in claim 4, characterized in that at least one current-limiting element (253) is provided for limiting the discharge current of the charge storage means (254).

10. The device as claimed in claim 9, characterized in that the at least one current-limiting element (253) is arranged in series with the discharge path of the high-pressure discharge lamp (20) and in series with the voltage-dependent switching means (131).

11. The device as claimed in claim 9, characterized in that the current-limiting element (253) comprises a resistor or an inductance or a combination of these component parts.

12. The device as claimed in claim 1, characterized in that a voltage converter (11) is provided, which serves the purpose of supplying voltage to the voltage-dependent switching means (131) during the ignition phase of the high-pressure discharge lamp (10) and of supplying the high-pressure discharge lamp (10) with a current of alternating polarity.

13. The device as claimed in claim 12, characterized in that the current of alternating polarity has a fundamental frequency of greater than or equal to 100 kHz.

14. The device as claimed in claim 12, characterized in that a filter network (12) is provided for protecting the voltage transformer (11) from voltage pulses generated by the voltage-dependent switching means (131).

15. The device as claimed in claim 14, characterized in that the filter network (12) is designed such that it contributes to the stabilization of the gas discharge in the high-pressure discharge lamp (10).

16. The device as claimed in claim 14, characterized in that the filter network (12) comprises at least one inductor (121).

17. A lamp base for a high-pressure discharge lamp (10) with a device according to claim 1.

18. A lighting system with at least one high-pressure discharge lamp and at least one device as claimed in claim 1.

19. A method for operating a high-pressure discharge lamp (10), voltage pulses for igniting a gas discharge in the high-pressure discharge lamp (10) being generated with the aid of a voltage-dependent switching means (131), characterized in that the switching threshold voltage of the voltage-dependent switching means (131) is greater than or equal to the ignition voltage required for igniting the gas discharge in the high-pressure discharge lamp (10).

20. The method as claimed in claim 19, characterized in that, in order to ignite the gas discharge in the high-pressure discharge lamp (10), a charge storage means (132) is charged to the switching threshold voltage of the voltage-dependent switching means (131).

21. The method as claimed in claim 20, characterized in that the charging of the charge storage means (132, 454) to the switching threshold voltage is carried out with the aid of a piezo transformer (37) and/or a voltage multiplication circuit (47).

22. The method as claimed in claim 19, characterized in that, with the aid of a voltage converter (11), a first supply voltage for the voltage-dependent switching means (131) is provided during the ignition phase of the high-pressure discharge lamp (10) and a second supply voltage for the high-pressure discharge lamp (10) is provided once the gas discharge in the high-pressure discharge lamp (10) has been ignited, for the purpose of producing a lamp current with alternating polarity.

23. The method as claimed in claim 22, characterized in that the voltage converter is in the form of an inverter or an alternating voltage converter, which is operated for producing the first and second supply voltage at switching frequencies from different frequency ranges.

24. The method as claimed in claim 22, characterized in that the voltage converter (11) is protected from the voltage pulses from the voltage-dependent switching means (131) with the aid of a filter network (12).

25. The method as claimed in claim 20, characterized in that the charge storage means (132), once the gas discharge in the high-pressure discharge lamp (10) has been ignited, is charged to a voltage which is smaller than the switching threshold voltage of the voltage-dependent switching means (131).
